(19) United States
(12) Patent Application Publication
(10) Pub. No.: US 2005/0010962 A1
(43) Pub. Date: Jan. 13, 2005

(54) Method and system for using broadcast channel frequencies to provide data services over an existing CATV system

(76) Inventors: Mark Bugajski, Norcross, GA (US); Bryant Isaacs, Alpharetta, GA (US); Mark Haverkate, Larkspur, CO (US); David Haverkate, Larkspr, CO (US); Dana Gillfillan, Alpharetta, GA (US); Angelo Blone, Lawrenceville, GA (US)

Correspondence Address: ARRIS INTERNATIONAL, INC, 3871 LAKEFIELD DRIVE, SUWANEE, GA, 30024, US

(21) Appl. No.: 10/850,616

(22) Filed: May 21, 2004

Related U.S. Application Data
(60) Provisional application No. 60/472,200, filed on May 21, 2003.
(60) Provisional application No. 60/482,640, filed on Jun. 26, 2003.

(51) Int. Cl. H04N 7/173

(52) U.S. Cl. 725/126; 725/105; 725/127; 725/120

(57) ABSTRACT

A direct broadcast satellite system delivers video content to a subscriber and a CATV network is used to simultaneously provide data services to the same subscriber. Since the CATV system is not used to deliver video/television programming channels, these same channels can be used to transport downstream and upstream data signals. To provide upstream performance and immunity to noise, upstream data traffic signals are upconverted at a subscriber's cable modem for transmission by channels having center frequencies higher than 54 MHz. Cable modem circuitry combines the conventional output signal with the output of a local oscillator to raise the carrier frequency of upstream traffic before it is introduced to the CATV network. Thus, upstream traffic can be carried by channels higher than 54 MHz. This upstream signal is received by a block converter that lowers the carrier frequency back to a conventional channel frequency before processing by a standard CMTS.

### CROSS REFERENCE TO RELATED APPLICATION

This application claims the benefit of priority under 35 U.S.C. 119(e) to the filing date of Bugajski, et. al., U.S. provisional patent application No. 60/472,200 entitled “Method and system for operating CATV system passive and active components at mid-split RF frequencies to enhance the upstream performance of high-speed data services”, which was filed May 21, 2003, and is incorporated herein by reference in its entirety. This application also claims the benefit under 35 U.S.C. 119(e) to Bugajski, et. al., U.S. provisional patent application No. 60/482,640 entitled “Mid-split converter for standard DOCSIS cable modem.”

### FIELD OF THE INVENTION

The present invention relates generally to broadband communication networks, and more particularly to a method and system for using broadcast channel frequencies for upstream and downstream data service channels over a CATV network while simultaneously providing video content to a user using the same broadcast channel frequencies.

### BACKGROUND

Community antenna television (“CATV”) networks have been used for more then four decades to deliver television programming to a large number of subscribers. The CATV networks have typically been implemented using coaxial cables that form a network for electrically providing a signal path for video signals in a direction from a central location, or head end, to the subscribers.

The need for an aerial antenna was eliminated and greater channel programming was made available when a subscriber obtained CATV services from a cable TV provider. Accordingly, the number of households having access to CATV signals grew as cable companies met the demand for cable television access. Deployment was initially in urban areas, then suburban areas and finally rural, or small town, areas.

A CATV system operator typically receives programming signals from a satellite, or satellites, with satellite antennas located at the central location. The satellite signals are received at the centrally located head end with receiving equipment, and the signals are formatted and frequency-converted so that a given program video feed signal can be provided from the head end to the CATV coaxial network at a given standard (NTSC in the United States) television channel, typically having a bandwidth of 6 MHz and a center frequency in accordance with the NTSC standard. Thus, a standard television set designed to receive broadcast television channels could be connected to a CATV network and, using its built-in tuner, receive the CATV programming.

Although a high percentage of homes presently have access to a CATV network, consumers have been steadily supplanting CATV systems for receiving television programming with their own satellite antennas, or ‘dishes’—so named due to the parabolic shape of the receiving antenna used in satellite systems. During the 1990's, dish systems became a significant competitor to CATV systems, because more channels are typically available than with a CATV system, and dish systems can be implemented in remote locations where a CATV system operator typically has no incentive to invest in the construction of coaxial cable infrastructure. This lack of incentive exists because the few subscribers that might decide to subscribe if a provider built a coaxial network, would most likely not offset the investment cost, much less result in profitability for the provider.

However, in some markets, where a subscriber base may be in the range of 5,000 to 20,000 subscribers, investment in coaxial cable networks may have been made before use of satellite dish receiver systems became widespread. Thus, some of these markets, referred to as ‘small size markets,’ that are typically located in rural locations are serviced by a coaxial cable network. While these networks may generate revenue to a provider, due to the tepid economic conditions that are typically characteristic of these small markets, providers are reluctant to invest in maintenance and upkeep of the systems other than the minimum necessary to provide basic operability to subscribers. Large upkeep and maintenance budgets would most likely result in insolvency for a provider's operations in these markets. Furthermore, subscribers in these markets have the option of choosing to use satellite dish receiver systems to receive television and video content. Thus, the performance of the cable network systems in many small markets suffers due to poor maintenance and worn and outdated equipment, with the result being that more and more subscribers are choosing satellite systems for receiving video and television content.

Aside from cable television network systems, use of the Internet continues to increase as a means of consumers receiving, and sending, information to providers and other Internet users. While use of the Internet typically requires a subscription with an Internet service provider (“ISP”), the Internet is available to practically anyone with a computer, because, in the United States, the federal government has for years required that telephony service be made available to everyone, no matter how remote. Thus, practically every resident living in a small market has the ability to connect to, and become part of, the Internet. Many in such small markets have taken advantage of the access, and more and more sign up for Internet service with a provider every day in small as well as large markets.

Plain old telephone service (“POTS”) continues to be the medium that most Internet users use to connect to the Internet. A connection to the Internet using POTS is typically referred to as a dial-up connection. However, as use of the Internet continues to grow, and the amount and size of information that composes Internet traffic continues to grow, users are demanding better and better performance for their Internet experience than can be provided by a dial-up connection. Telephony companies have predictably responding to this demand by upgrading equipment at their central locations, typically referred to as central offices, to implement digital subscriber lines, or “DSL.” A DSL line, connected to Digital Subscriber Line Access Module at a central office can transmit and receive the digital information signals, referred to herein as “data,” at much faster rates than can be achieved using POTS and a dial-up connection.

However, telephony service providers are not required to upgrade their central office equipment to provide high-speed Internet, or data, service, also referred to as “broadband” service, to rural or remote locations, even though they are required to provide POTS service to such locations, and even though POTS and DSL service can be provided over the same twisted conductor pair. Thus, small market consumers may be able to receive video content and television content via a satellite-dish-receiver-system, but still may not have access to broadband data services.

In small markets where there is a CATV video system presence, subscribers may be able to have both broadband data and video services from the CATV service provider if the CATV system operator has upgraded some equipment at the central location to accommodate data delivery over the CATV coaxial network. Such upgraded equipment may typically comprise a Cable Modem Termination System (“CMTS”) for providing data services over the same coaxial cables used to deliver traditional cable television signals to subscribers. In such a system, subscribers typically use a cable modem at their premises. The data is transported over the coaxial cable network typically using the Data Over Cable Service Interface Specification (“DOCSIS”) protocol and video content is provided using the standard NTSC 6 MHz channel arrangement that is used by broadcast television stations. In the DOCSIS scheme, 6 MHz channels having center frequencies between 5 and 42 MHz are typically used for upstream transmission from the cable modem at the subscriber premises to the CMTS. It will be appreciated that the DOCSIS protocol in countries other than the United States may use a slightly different scheme, as channel spacing and frequency may be slightly different from country to country. Channels having center frequencies between 54 MHz up to about 750 MHz are typically used for delivering downstream video content, with certain channels being reserved for downstream data services from the CMTS to the subscriber's cable modem. Thus, the subscriber can access broadband data services and video content from the same coaxial drop from the coaxial network.

However, data transmission over coaxial cable using DOCSIS has some inherent limitations, such as, for example, if more than one subscriber is receiving downstream data transmissions over the same channel as designated by the CATV network operator, then the total bandwidth available within that 6 MHz channel is divided among the subscribers. Thus, to accommodate a large number of users simultaneously, the system operator may have to designate many 6 MHz channels. While this is common practice in a DOCSIS system, more channels being reserved for data results in fewer channels being available for video content. If cable system operators maximize the number of video channels provided to subscribers in order to compete with the large number of channels available from satellite providers, then the number of channels that can be designated for data may impose a limit on the available bandwidth for data when many users are receiving data from the CMTS simultaneously. This number of channels may be further limited by the state of repair of the coaxial cable network in the small markets. As discussed above, the CATV operators in small markets may be reluctant to properly maintain their coaxial infrastructure, due to the low rate of return these investments typically bring. Therefore, while the coaxial networks in small markets may be adequate to provide acceptable video service to subscribers, the state of repair may not be high enough to support optimal data transmission using the DOCSIS protocol. Data traffic transmitted in either direction (upstream or downstream) may be delivered over such a poorly maintained system, but the speed at which data can be transmitted without significant errors may be severely reduced.

Such reduced performance may be influenced by a number of factors, including, but not limited to, cracked or broken insulation on coaxial cables and loose or corroded coaxial connectors and/or external equipment housings in the field that may be cracked or not properly sealed. These types of flaws in a coaxial network system are points that permit electrical impulses, or noise, to enter the coaxial cable network. The noise sources are typically located near an entrance point, such as a cracked cable or corroded connector, and may include electromagnetic radiation from household sources such as, for example, electric motors, arcing occurring in electrical switches, or other sources of radiation at a relevant frequency, including ham radio waves and aeronautical communication signals.

Energy at these frequencies can enter the coaxial cable plant at any of the afore-mentioned entrance points, and tend to be cumulative within the cable network. Moreover, such energy signals typically have frequency components predominantly in the 5-15 MHz range, but have substantial energy components up to 42 MHz as well. It will be appreciated that these frequencies typically correspond to the frequency range that the upstream DOCSIS channels use to transmit data from a subscriber toward the CMTS. Thus, upstream transmission of DOCSIS data signals from a subscriber to the CMTS at the head end may be slow at best and have so many errors at worst so as to be unusable. Since the noise sources tend to occur at frequencies below the frequency ranges used for downstream transmission of data, transmission of downstream data does not typically suffer as much from noise intrusion.

Thus, there is a need for a system that facilitates the providing of video content at traditional downstream television channel frequencies so that a subscriber's existing television equipment can be used. Moreover, there is a need for this system to be capable of also facilitating upstream and downstream data transmission between a cable modem and a CMTS that is not significantly affected by noise that enters through entry points that may be the result of neglected maintenance. The system should be configured to provide the data service and video service at a convenient connection so that a user's existing cable modem connection and television connection are used.

### SUMMARY

A system joins wired broadband network access and wireless video content access to provide a subscriber with the best of both worlds. An existing coaxial cable television network, or CATV network, is used to provide data traffic to a subscriber. Television programming is delivered via a satellite dish system. Therefore, since the CATV network does not have to deliver television channels, the spectrum frequencies normally used for these channels can be used for data transmission.

This facilitates more data bandwidth in the downstream direction as opposed to an existing DOCSIS system where a CATV network is used for both television and data signals, because channel frequencies used for television channels in such a system that are not otherwise available for data can be used for data. In addition, upstream data traffic performance is improved because the frequency range for upstream traffic, which under existing DOCSIS arrangements is typically 5-42 MHz, can be shifted to higher frequencies, such as, for example, 100-180 MHz. Thus, upstream traffic is transported using frequencies that are higher than the frequencies at which ingress and other noise typically occur, therefore substantially reducing data error rates.

A mid-split cable modem may be used to transmit upstream data traffic at the higher frequencies and a block frequency converter may be used at the head end to change the higher carrier frequencies of the upstream traffic signals received from cable modems into frequencies expected by an existing DOCSIS CMTS. Thus, a CATV operator need not expend large amounts of money to upgrade an existing cable plant, or infrastructure, (i.e., replacing coaxial cable and connectors that have degraded and become damaged over time), which may be adequate for providing cable television programming signals, but not adequate for providing data traffic at broadband speeds. Typically, the only plant upgrades that would be made would be to replace existing amplifiers, which may be only one way amplifiers for use in the downstream direction, with two way amplifiers that are designed to operate in the upstream direction at frequencies at or above than 54 MHz.

As defects in the cable plant may exacerbate the ingress of noise through broken insulation and corroded connectors, for example, raising the carrier frequencies for upstream traffic transmitted over the cable plant places the upstream traffic signals out of the range of many noise sources, thereby facilitating higher transmit speeds because of fewer errors. A splitter may be used at the subscriber's premises to couple a feed from a subscriber's satellite dish with the data connection over the CATV network. A subscriber would have a single coaxial cable connection point from which data and television programming is received and transmitted, as is the case when a CATV provider provides television programming and data services over the same coaxial cable. Thus, a subscriber's internal wiring in a house or office would not require upgrading.

In addition, because the spectrum normally reserved for television programming is not used to carry commercial television programming content over the CATV network, some of these channels are available for local television programming. For example, programming from a small cable television station that exclusively carries local community service programming, that carries local church services, or that may be a local university's campus television channel, can be carried on the downstream channels that would otherwise be used for commercial programming. Thus, a subscriber would have access to even more television programming, as the commercial programming would be received using the satellite dish and would not interfere with programming carried at similar channel frequencies over the CATV network.

### BRIEF DESCRIPTION OF THE DRAWINGS

FIG. 1 illustrates a typical existing CATV network configuration where upstream data signals are transported in the frequency range of 5-42 MHz.

FIG. 2 illustrates a system that uses an existing CATV network where upstream data signals are transported in the frequency range of 100-180 MHz and where video television programming is delivered to a subscriber via a satellite dish.

FIG. 2A illustrates an alternative system that uses an existing CATV network where upstream data signals are transported in the frequency range of 100-180 MHz and where video television programming is delivered to a subscriber via a satellite dish.

FIG. 2B illustrates another alternative system that uses an existing CATV network where upstream data signals are transported in the frequency range of 100-180 MHz and where video television programming is delivered to a subscriber via a satellite dish.

FIG. 3 illustrates circuitry to be used with existing cable modem circuitry to facilitate upstream data transmission at mid-split frequencies.

### DETAILED DESCRIPTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. This disclosure is not intended nor is to be construed to limit the present invention or otherwise to exclude other embodiments, adaptations, variations, modifications and equivalent arrangements, the present invention being limited only by the claims appended hereto and the equivalents thereof.

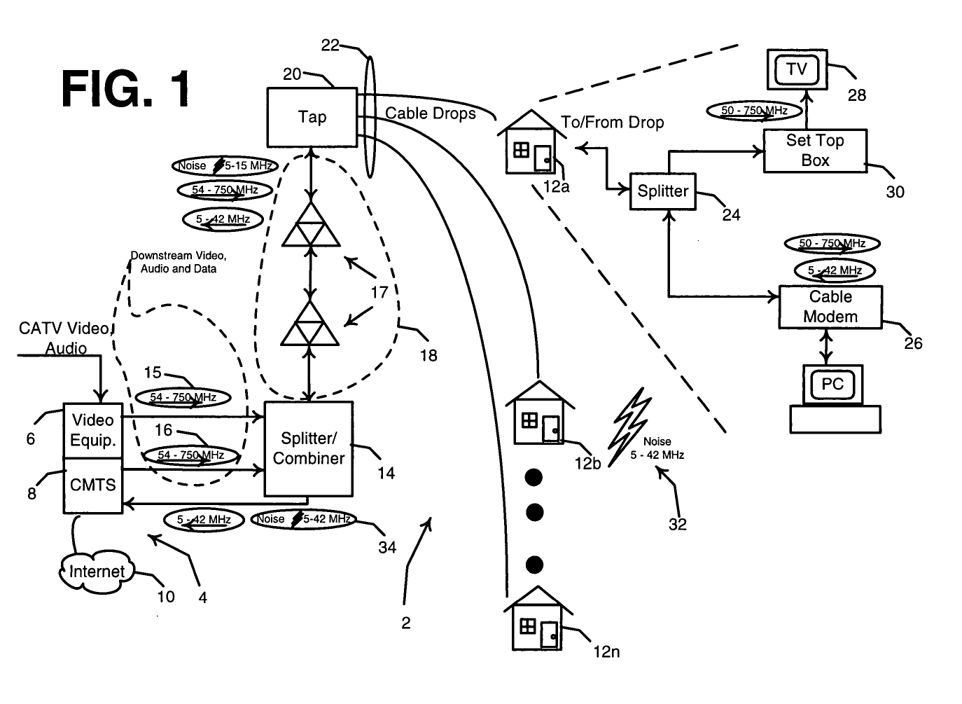

Turning now to the figures, FIG. 1 illustrates an existing system 2 for providing television programming signals and data signals over a CATV network. A service provider's central location 4 typically comprises a head end 6 at the central location for providing television programming signals to the network and a CMTS 8 for interfacing with a data network, such as the Internet I will be appreciated the central location is sometimes referred to in the art, and herein, as the head end. Thus, item 6 in the figure is labeled as ‘video equip.’ to distinguish this equipment from equipment at the head end location that provides data services. Data from Internet 10 and audio and video signals received at the head end are combined together for transport to a plurality of subscribers 12 using splitter/combiner 14.

Video signals 15 and data signals 16 are typically transmitted in a downstream direction (from central location toward subscribers) at frequencies typically ranging from 54-750 MHz. Signals are typically transported over channels having a bandwidth of 6 MHz. To transmit downstream data channels using the DOCSIS protocol, certain channels that would otherwise be used for video, are reserved for data transmission only. Such a system is known in the art, and the selection of which channels to reserve for data is typically made by the CATV system operator.

The combined signals are amplified with amplifiers 17, which may be only one-way (downstream) if the CATV system has only been used for video broadcast signals, or two-way (as shown in the figure) if currently used for a DOCSIS/video system. If the latter, amplifiers 17 are typically tuned to operate in 54-750 MHz range in the downstream direction and 5-42 in the upstream direction. The signals are sent over coaxial cable network 18, which may include amplifiers 17. Tap 20 provides an interface to cable drops 22, which facilitate individual network access for individual subscribers 12.

When the combined signals are received at the subscriber's premises 12, splitter 24 provides a feed to a cable modem 26 and to a television set 28, which may include a set top box 30, as known in the art. Moreover, cable modem 26 introduces DOCSIS upstream data traffic to splitter 24 for transmission to CMTS 8 at a frequency in the range of 5-42 MHz.

It will be appreciated that noise energy 32 from electrical motors, arcing from electrical switches, and RF energy from over-the-air signals in the 5-42 MHz frequency range may be introduced into the system and result in noise signals that propagate throughout the system. Noise signals 34 resulting from noise energy 32 can cause errors in data transmission. Since noise 32 typically has energy components primarily in the 5-42 MHz range, using the standard DOCSIS scheme of transmitting upstream data in the 5-42 MHz range can result in severely degraded upstream performance. This can be a problem for CATV providers in rural/small markets who want to continue to receive revenue from existing CATV networks, but who cannot justify upgrading to hybrid-fiber systems, which are known in the art, or even replacing degraded coaxial cable with fresh cable and connectors.

However, due to the widespread availability of satellite dish receiver systems for receiving television programming at monthly rates that compete with CATV monthly rates, operators of existing CATV systems, especially those in rural areas, are faced with a dilemma. This is because a potential subscriber can receive television programming as well as data services via satellite, although it will be appreciated that upstream data over satellite is not currently available and dial-up telephony modems are used for upstream transmission of data signals in a satellite system.

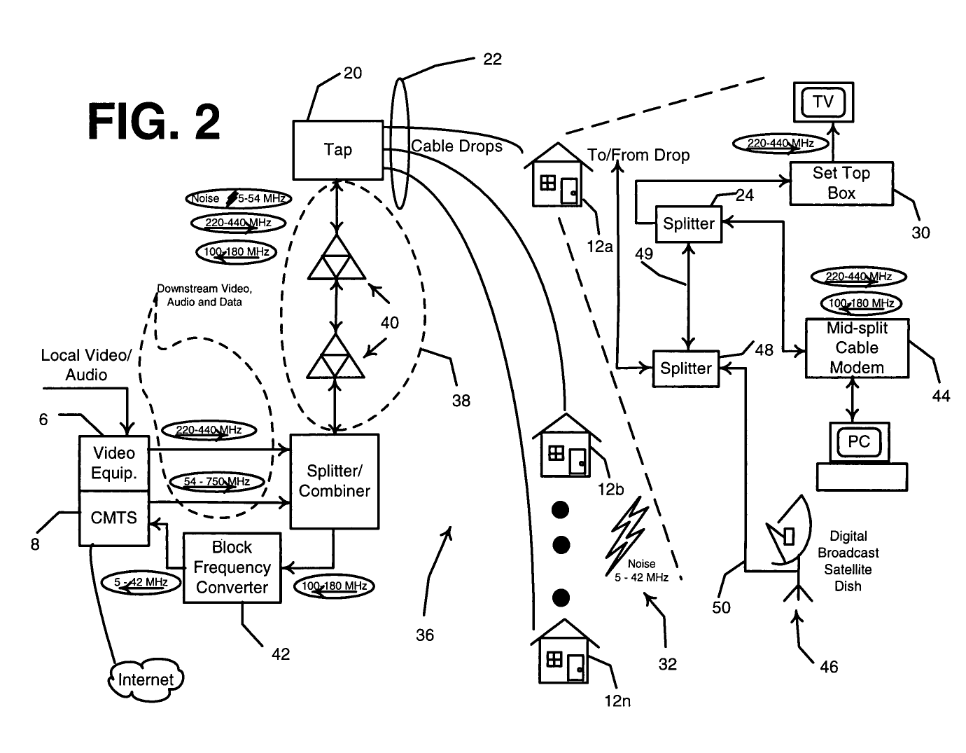

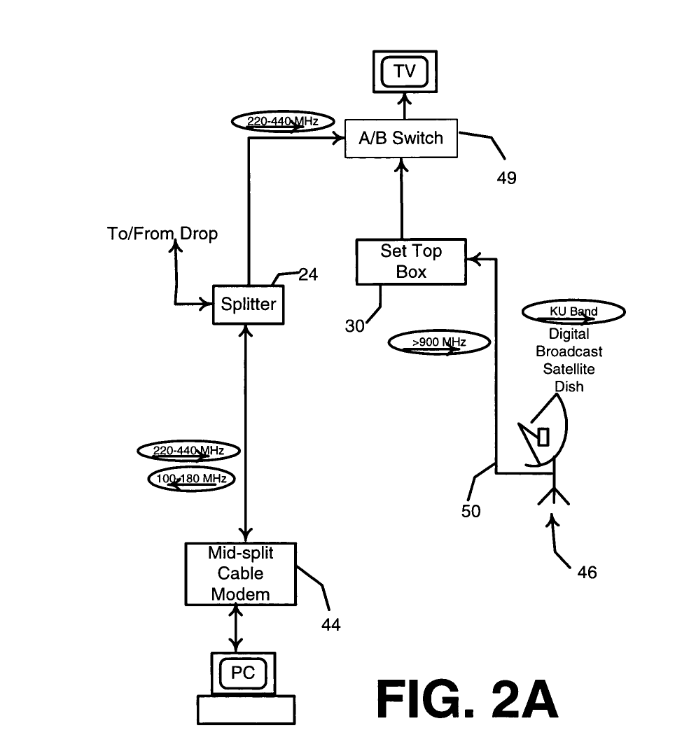

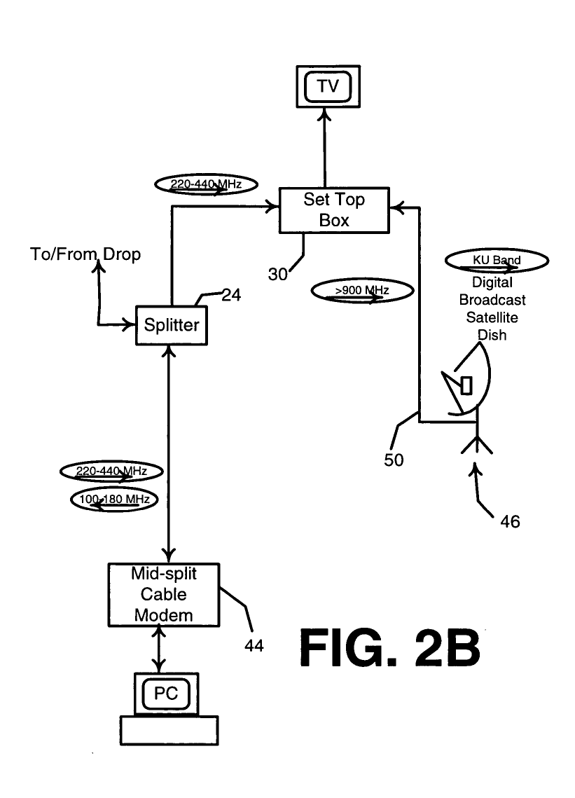

To address this dilemma of either investing in upgrading of the cable plant or risk loosing video customers to satellite dish providers, system 36 shown in FIG. 2 can be implemented. An existing CATV system network 38, similar to network 18 in FIG. 1, is used to provide data services from CMTS 8 to subscribers 12. The same coaxial cables and connectors of network 18 are used in network 38, except that amplifiers 17 are replaced with amplifiers 40. For upstream transmission, amplifiers 40 are designed to operate preferably in the range of 100-180 MHz. In conjunction with the raised upstream traffic frequency range, block frequency converter 42, located at the CATV provider's central location, converts the higher frequency signals into signals having carrier frequency in the standard DOCSIS 5-42 MHz range. This allows use of a standard CMTS 8 so that upgrading this device, which is costly relative to the cost of amplifiers 40, can be avoided. The higher frequency upstream signals are generated at cable modem 44, which preferably operates at frequencies higher than a mid-split split point in the upstream direction, and of which further details will be provided later in this description.

Thus, by integrating mid-split cable modem 44, mid-split amplifiers 40 and block converter 42 into an existing CATV network, data can be reliably transmitted at broadband speeds in the upstream direction without the need for replacing deteriorated and degraded coaxial cable and connectors, or without the need for upgrading portions of coaxial network 18—shown in FIG. 1—to fiber optic cable. Since portions of the spectrum that are traditionally allocated for downstream video broadcast and downstream data transport are used for upstream data transmission in mid-split system 36, video content can be provided by a means other than from head end 6. Thus, more channels in the preferably mid-split range can be used for upstream data traffic than in a conventional DOCSIS scheme where only 6 channels are available in the 5-42 MHz range.

To provide video content to subscribers 12, system 36 uses Direct Broadcast Satellite (“DBS”) receiving system 46. Such a DBS system 46 is known in the art, and is commercially available from multiple service providers, such as EchoStar Communications Corporation. Instead of connecting system 46 directly to set top box 30 as is customary with DBS systems, the DBS system is connected to splitter/combiner 48, which also couples drop lines 22 from tap 20. Splitter/combiner 48, also referred to as a common termination point device, couples with existing splitter/combiner 24 so that a single coaxial connection 49 provides connectivity between a subscriber's 12 premise equipment, such as set top box 30 and mid-split cable modem 44, DBS feed 50 and drop 22, which may also be referred to as a coaxial cable network interface. The portion of the coaxial able network located on the head end side of splitter 48 may be referred to as the provider's coaxial cable network plant. The cabling that connect set top box 30 and modem 44 to splitter/combiner 24 may be referred to as the portion of the coaxial cable network that is located at the subscriber's premises.

Satellite system 46 typically receives video content transported by channels in the KU band. Thus, DBS satellite feed 50 carries video content signals at different frequencies than those at which CATV network 38 operates, and channels at the conventional broadcast channel frequencies can be used to transport upstream (as well as downstream) data over the CATV network.

As discussed above, these frequencies are above the range where most ingress noise energy 32 occurs. Thus, upstream data traffic transport performance is improved vis-á-vis a conventional DOCSIS system that uses the range of 5-42 MHz to transport upstream data. And, since many of the conventional downstream channels over the cable network 38 are available because they are not used to transport commercial video content from head end 6, they can be used to provide an increase in downstream bandwidth from CMTS 8 to cable modem 44 vis-á-vis a conventional DOCSIS scheme as shown in FIG. 1.

Furthermore, since many channels in the ranges normally allocated from downstream broadcast signals are available, notwithstanding the channels that are used for upstream data and downstream data, frequencies in the range above 54 MHz may be used to transmit local television channels from head end 6. These channels may be received at head end 6 from over-the-air antennas for commercial network affiliates, such as, for example, FOX, NBC, CBS and ABC. In addition, smaller community-service stations and feeds, such as, for example, local colleges and/or local government may be received and provided to subscribers 12 by head end 6.

Due to the crowded nature of the spectrum and the preference for commercial channels when video content is transported from head end 6 to subscribers 12 in a conventional CATV system, there is typically little spectral space available for this less profitable, yet often desired-by-subscribers, programming. Thus, an additional advantage of having access to these local stations is facilitated by using mid-split system 36. It will be appreciated that ‘mid-split’ is a term sometimes used in the art to refer to a frequency scheme that facilitates bi-directional traffic on a single coaxial cable. Reverse channel signals propagate to the head end at frequencies from 5 MHz to a split point and forward path signals propagate from the head end at frequencies within a range starting at a frequency above the split point to the upper frequency limit of the system. However, since there is not a frequency split point defined by an industry standard as being mid-split, the term mid-split is used herein to refer to a frequency scheme having a split point at 54 MHz. Accordingly, the frequencies that normally carry signals propagating in the upstream direction in a conventional DOCSIS system are not use to transport signals across coaxial cable plant 38. Frequencies above the split point are used for upstream as well as downstream data signal propagation. A signal that has propagated from a subscriber 12 to head end location 4 across cable plant 38 is converted back to the conventional DOCSIS upstream band before being presented to CMTS 8. It will be appreciated that the preferred embodiment uses a split point of 54 MHz, but embodiments that use other split points can also be used and are within the scope of this description and claims appended hereto.

In an alternative embodiment shown in FIG. 2A, A/B switch 49 is coupled to a subscriber's television set. Set top box 30 is coupled to DBS system 46 at a first connection and splitter 24 is coupled at a second connection, such that if a video content signal from splitter 24 is at a channel frequency that conflicts with a video content channel from system 46, the subscriber can manually select the desired programming. It will be appreciated that set top box 30 converts the typically 900 MHz and above channel frequencies received on feed 50 to standard broadcast channel frequencies for reception by standard television equipment. It will also be appreciated that the DBS KU band signals are down converted to the 900 MHz and above frequencies by an LNB located at the dish, as known in the art. Thus, existing television equipment, especially older television sets that have only one antenna input and use a rotary dial tuner, can receive video content from the DBS system 46 as well as from a providers head end equipment that may be providing local and community interest programming, as discussed above.

In another alternative embodiment illustrated in FIG. 2B, set top box 30 receives video signals from system 46 over feed 50 at a DBS port and is coupled to splitter 24 at a broadcast channel frequency port. The output of set top box 30 is connected to television equipment, either on an RF connection or on line level connections that allow the television tuner to be bypassed for higher quality audio and video reproduction. Such connections are known in the art. If conflicts between programming channels occur, as discussed above in reference to FIG. 2A, set top box 30 can provide an interface and functionality for a user to select which of the conflicting channels to view. A further advantage is provided over the system illustrated in FIG. 2, as splitter 48 shown in FIG. 48 is eliminated thereby resulting in less signal loss to the television equipment and to cable modem 44.

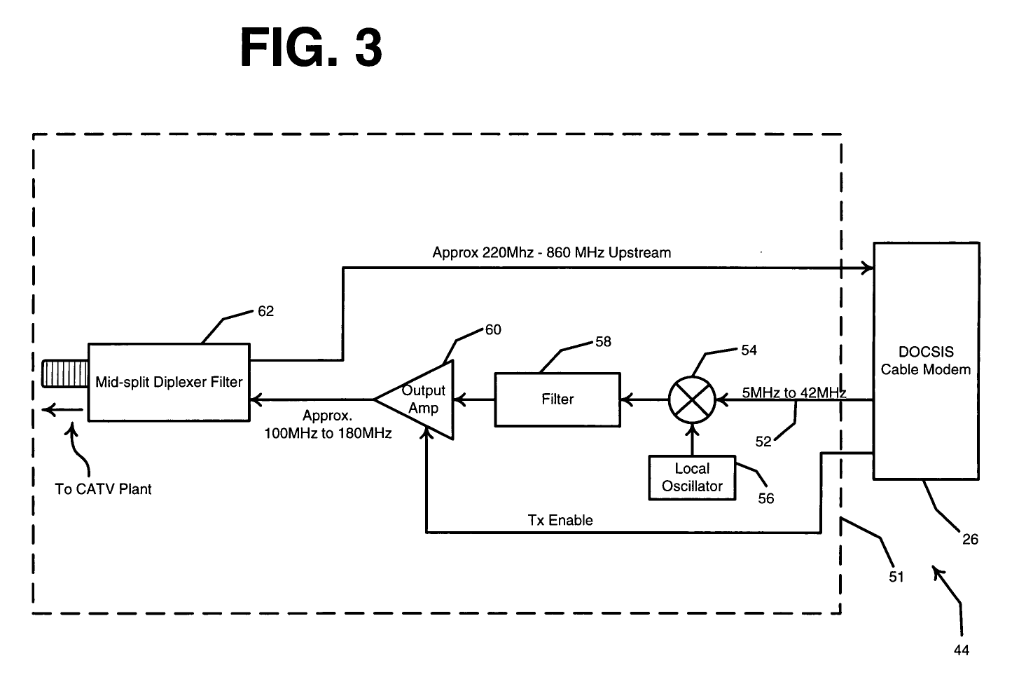

Turning now to FIG. 3, a block diagram of upconverter circuitry 51 added to standard cable modem circuitry 26, as referenced in FIG. 1, is shown. When upconverter 51 is incorporated with modem 26, the result is modem 44 referred to in FIG. 2, that provides upstream traffic at frequencies higher than the standard DOCSIS 5-42 MHz conventionally used for upstream traffic. Thus, upgrades to standard cable modem circuitry facilitates system 36 referred to in FIG. 2.

The conventional upstream traffic signal 52 from modem 26 is mixed at mixer 54 with the output signal from local oscillator 56 to provide a higher carrier frequency for the traffic signal 52 being provided from the standard cable modem circuitry. As an example, if an upconverted upstream range of 100 to 180 MHz is desired, and the input signal 52 from cable modem circuitry 26 covers the range of 5 to 85 MHz, then a local oscillator frequency of 95 MHz would result in the upstream traffic being output from mixer 54 in the desired range of 100-180 MHz. This output is then filtered by high pass filter 58 to remove remnants of the local oscillator frequency and the original 5-85 MHz carrier frequencies. The filtered output of filter 58 is provided to amplifier 60 to bring the overall gain of the oscillator/mixer/filter components to one. The output of unity gain amplifier 60 is provided to diplex filter 62, which is preferably designed to pass frequencies in the upstream direction to the cable plant between 5 and 180 MHz, and to pass frequencies in the downstream direction from the cable plant above 180 MHz.

Thus, existing cable modem circuitry 26 can be advantageously modified with the addition of circuitry 51 to provide upstream data traffic from a subscriber at frequencies higher than the conventional DOCSIS 5-42 MHz range. However, as described in reference to FIG. 2, these higher frequencies are downconverted by block converter 42 so that DOCSIS CMTS 8 still receives upstream traffic at frequencies in the conventional range of 5-42 MHz. It will be appreciated that channel frequencies in the range up to about 750 MHz may be supported, but that due to the often deteriorated condition of a provider's cable plant, the actual bandwidth physically achievable may be lower. Thus, the frequency ranges shown in the figures and described herein were chosen for purposes of example only.

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents.

1. A system for simultaneously providing to at least one subscriber video services and data services at broadcast channel frequencies over a provider's coaxial cable network plant, comprising:
a means for transmitting and receiving digital data at the at least one subscriber's premises, said transmitting and receiving means being coupled to a portion of the coaxial cable network that is located at the subscriber's premises and being capable of receiving and transmitting data signals at broadcast channel frequencies; and
a video receiving means for receiving video content signals located at the at least one subscriber's premises, wherein said video receiving means is capable of transporting at frequencies that are higher than broadcast channel frequencies the received video content signals, said video receiving means being coupled to the portion of the coaxial cable network that is located at the subscriber's premises and to the provider's coaxial cable network plant.

2. The system of claim 1 further comprising at least one two way amplifier, said two-way amplifier being coupled at a head end port and a subscriber side port between a service provider's head end and the at least one subscriber's premise equipment respectively.

3. The system of claim 2 further comprising a block frequency converter between the head end port of the at least one two-way amplifier and a data network interface device located at the service provider's head end location.

4. The system of claim 1 wherein the means for transmitting and receiving digital data includes a cable modem configured to transmit upstream data to the coaxial cable network at broadcast channel frequencies.

5. The system of claim 1 wherein the video receiving means includes a satellite receiving system.

6. The system of claim 1 further comprising a common termination point device that couples the coaxial cable network interface and the video receiving means with the portion of the coaxial cable network that is located at the subscriber's premises.

7. The system of claim 6 wherein the common termination point device is a splitter/combiner.

8. The system of claim 3 wherein the block frequency converter is capable of converting a signal having a carrier frequency corresponding to a broadcast channel frequency into a signal having a carrier frequency lower than broadcast channel frequencies.

9. A method for providing data services over a coaxial cable network to one or more subscribers, wherein television programming is simultaneously provided to the one or more subscribers, comprising:
coupling a DBS system to the one or more subscriber's television premise equipment;
coupling a data services interface equipment of the one or more subscribers to the coaxial cable network, the data services interface equipment being capable of transmitting upstream data signals at elevated channel frequencies that are higher than a mid-split split point; and
inserting a block frequency converter between the coaxial cable network and a CMTS for converting the elevated upstream channel frequencies to channel frequencies below said split point before said upstream channel frequencies are provided to the CMTS.

10. The method of claim 9 wherein the DBS system is coupled to a first coupling device, the first coupling device also being coupled to the coaxial cable network and to the one or more subscribers' premise equipment, for providing television programming signals and data services to the one or more subscriber's premise equipment at a subscriber premise equipment port.

11. The method of claim 10 wherein a second coupling device is coupled to the subscriber premise equipment port, and to television equipment and the data services interface equipment for combing a signal from the DBS system with a signal from/to the coaxial cable network into a combined signal, and for providing an interface between said combined signal and said television equipment and data services interface equipment.

12. The method of claim 11 wherein the data services interface equipment is a cable modem capable of transmitting upstream data at channel frequencies higher than the mid-split split point.

13. A method for providing data services to a subscriber over a coaxial cable network, comprising:
upconverting the carrier channel frequency of an upstream data signal to a frequency above a mid-split frequency;
transmitting the upconverted upstream data signal over a coaxial cable network towards a CMTS at a head end location;
receiving the upconverted upstream data signal at the head end location;
downconverting the upconverted upstream data signal at the head end location; and
providing the downconverted upstream data signal to the CMTS.

14. The method of claim 13 further comprising providing video content signals to the subscriber at channel frequencies higher than conventional broadcast channel frequencies.

15. The method of claim 14 wherein the channel frequencies higher than conventional broadcast channel frequencies are in the KU band.

16. Circuitry for converting upstream data traffic signals of a communication device from standard upstream channel frequencies to higher channel frequencies, comprising:
a means for generating a fixed-frequency signal;
a means for combining the fixed-frequency signal with the upstream signals to provide an upconverted upstream data traffic signal having a higher carrier frequency than the original upstream traffic signals; and
a means for combining the upconverted upstream traffic signal with downstream traffic signals, and for providing an interface between the combined upconverted traffic signals and the downstream traffic signals at a network connection point.

17. The device of claim 16 wherein the communication device includes a cable modem.

18. The device of claim 16 wherein the means for combining the fixed-frequency signal with the upstream signal includes a mixer.

19. The device of claim 16 wherein the means for providing the fixed-frequency signal includes a local oscillator.

20. The device of claim 16 wherein the means for combining the upconverted upstream traffic signals with the downstream traffic signals includes a diplex filter.

21. The device of claim 16 further comprising a means for detecting when the communication device is attempting to transmit an upstream traffic signal, wherein said detecting means provides an upstream-transmit trigger signal in response to a detected attempt to transmit upstream traffic at a trigger output.

22. The device of claim 16 further comprising an amplifier having
a signal input coupled to the output of the means for combining the fixed-frequency signal with the upstream signal;
a means for detecting when the communication device is attempting to transmit an upstream traffic signal, wherein said detecting means provides at a trigger output an upstream-transmit trigger signal in response to a detected attempt to transmit upstream traffic; and
a trigger input coupled to the detecting means.

23. The device of claim 22 further comprising a filter means for removing frequency components corresponding to the carrier frequencies of the original upstream traffic signal and the fixed-frequency signal, said filter means being coupled between the output of the means for combining the fixed-frequency signal with the upstream signal and the input of the signal input of the amplifier.

24. A method for upconverting an original upstream traffic signal into an upconverted upstream traffic signal comprising:
receiving the original upstream traffic signal from a communication device;
mixing the original upstream traffic signal with a fixed-frequency signal to produce an upstream traffic signal having a higher carrier frequency than the original upstream traffic signal; and
providing the upconverted traffic signal to a combining means for coupling the upconverted upstream traffic signal and a received downstream traffic signal at a network connection point.

25. The method of claim 24 further comprising:
detecting when an original upstream traffic signal has been originated by the communication device; and
enabling an amplifier means that receives the upconverted upstream traffic signal at a signal input to provide said upconverted upstream traffic signal at an output.
